(19) United States
(12) Patent Application Publication
(10) Pub. No.: US 2016/0210587 A1
(43) Pub. Date: Jul. 21, 2016

(54) Method for documenting the delivery process for objects, in particular packages or letters

(71) Applicant: SIEMENS AKTIENGESELLSCHAFT, München (DE)

(72) Inventors: GISBERT BERGER, BERLIN (DE); JOERG-ANDREAS ILLMAIER, KREUZLINGEN (CH); MICHAEL ZETTLER, ALLENSBACH (DE)

(21) Appl. No.: 14/915,390

(22) PCT Filed: Aug. 18, 2014
(86) PCT No.: PCT/EP2014/067559

§ 371 Date: Feb. 29, 2016

(30) Foreign Application Priority Data
Aug. 29, 2013 (DE) 10 2013 217 283.4

(51) Int. Cl. G06Q 10/08; G06F 17/30

(52) U.S. Cl. CPC G06Q 10/0833; G06F 17/30312

(57) ABSTRACT

A method documents the delivery process for objects, in particular packages or letters, in which method, in the time span between receiving the objects for the purpose of transporting them and the final delivery of the objects at the target location, the objects are each detected individually and stored, in the form of a data set in a database and, after delivery of each object at the target location, the object is designated as delivered. Accordingly, within the framework of individually detecting the objects, target geodata which define the respective target locations are added to the respective data sets. When the objects are delivered at the target location, delivery geodata which define the location of the delivery are determined by a mobile detection device. The association of the delivered object with one of the data sets stored in the database requires that the target geodata correspond to the delivery geodata.

The invention relates to a method for documenting the delivery process for objects, in particular packages or letters, in which, in the time interval between receiving the objects for the purpose of transporting them and the final delivery of the objects at the target location, the objects are each detected individually and stored in the form of a data set in a database and during or after delivery of each object at the target location the object is designated as delivered in the assigned data set.

In order to allow unambiguous identification and the correct issuing of delivery receipts when delivering objects, it is known to use barcodes and ID tags to mark each of the objects unambiguously. At the time of delivery the barcodes or ID tags are read using manual devices and an acknowledgment of receipt is assigned to the respective barcode or ID tag, for example in the form of a signature.

It is the object of the invention to specify a reliable method for documenting the delivery process for objects that can be achieved without the use of barcodes or ID tags.

According to the invention this object is achieved by a method having the features of claim 1. Advantageous embodiments of the inventive method are set out in subclaims.

Provision is therefore made according to the invention in the context of the individual detection of the objects for target geodata that defines the respective target location to be added to the respective data set, on delivery of the objects at the target location for delivery geodata that defines the delivery location to be determined by means of a mobile detection device and for the assignment of the respectively delivered object to one of the data sets stored in the database also to require at least that the target geodata corresponds to the delivery geodata.

The term geodata here refers to digital information to which a defined spatial position on the surface of the earth can be assigned. For the address “Nonnendammallee 101 in Berlin” the corresponding geodata in KML format (Keyhole Markup Language format) would be for example “52.537455, 13.262857”.

One important advantage of the inventive method is that it allows an assignment of objects to be delivered to an individually assigned data set that documents the delivery of the respective object, even without the use of barcodes or ID tags. In many instances an unambiguous assignment of the objects can already be achieved without further ado based on the target geodata and the delivery geodata.

In the event that two or more objects are to be delivered for defined delivery geodata and unambiguous identification of objects is not possible based on the target geodata alone, provision is made according to the invention in the context of the individual detection of the objects for an image to be produced for each object and image features of the image produced to be stored in the respective data set, on delivery of the objects at the target location for a further image to be produced, the image features of the further image being compared with the image features of the data sets stored in the database and the assignment of the respectively delivered object to one of the data sets stored in the database also taking place at least based on the result of the image comparison.

Provision is also made according to the invention for the image comparison between the image features of the further image recorded on delivery at the target location and the image features of the data sets stored in the database to take place in a restricted manner, solely using image features of data sets for which target geodata corresponding to the respective delivery geodata is stored in the database.

The assignment of the respectively delivered object to one of the data sets stored in the database preferably takes place only if at least the image features of the further image produced on delivery of the object at the target location are identical or at least sufficiently similar to image features of one of the data sets stored in the database and the target geodata corresponds to the delivery geodata.

Delivery geodata and target geodata are preferably deemed to correspond, if the delivery geodata defines a delivery location which is located within a predetermined distance of the target location defined by the target geodata.

If despite the comparison of the target geodata with the delivery geodata and despite a comparison of image features an unambiguous assignment of the objects is not possible, it is deemed advantageous if, in the event of ambiguity in the assignment of the respective object to the data sets stored in the database, all the data sets under consideration based on the image comparison, in particular the restricted image comparison, or at least the image features of these data sets under consideration are displayed on the mobile detection device at the delivery location.

The assignment of the respectively delivered object to one of the data sets stored in the database in the last-mentioned instance preferably takes place based on a selection signal input into the mobile detection device by a delivery operator delivering the object after the objects under consideration based on the ambiguity have been displayed.

It is also possible to provide for identification based on recipient names. In this respect in a further advantageous embodiment of the method provision is made in the context of the detection of the objects for the recipient name in each instance to be added to the respective data set and in the event of any ambiguity in the assignment of the respective object to the data sets stored in the database for all the data sets under consideration based on the image comparison, in particular the restricted image comparison, or at least the recipient name stored in said data sets to be displayed on the mobile detection device at the delivery location.

With the last-mentioned variant the assignment of the respectively delivered object to one of the data sets stored in the database preferably takes place based on a selection signal input into the mobile detection device by a delivery operator delivering the object after the recipient names under consideration based on the ambiguity have been displayed.

An identification of the objects particularly preferably takes place by means of a mobile detection device. In this respect it is deemed to be advantageous if, before the start of a delivery process relating to a plurality of objects, the data sets relating to said objects and stored in the database are transferred to the mobile detection device to be used for their delivery and stored there.

The image comparison, in particular the restricted image comparison, preferably takes place using a computation facility of the mobile detection device based on the data sets stored on the mobile detection device.

Alternatively an image comparison can also take place away from the mobile detection device, for example in a central facility. In this respect in an alternative embodiment of the method provision is made for the image features of the further images recorded by the detection device and preferably also the delivery geodata to be transferred to this central facility and for the image comparison, in particular the restricted image comparison, to take place based on the image features of the further images recorded by the detection device in the central facility.

The invention also relates to a mobile detection device for documenting a delivery process for objects, in particular packages or letters.

According to the invention provision is made in respect of such a mobile detection device for the detection device to have a locating facility for generating delivery geodata.

For the advantages of the inventive detection device, see the above details relating to the inventive method, as the advantages of the inventive method correspond essentially to those of the inventive detection device.

It is deemed particularly advantageous for the detection device also to have: an image recording facility which can be used to produce an image of an object to be delivered, a storage facility which is intended to receive and store data sets relating to a plurality of objects which are stored in a database of a central facility and the delivery of which is to be detected by means of the detection device and a computation facility which is suitable for performing an image comparison, in particular a restricted image comparison, based on the data sets stored on the mobile detection device.

The invention further relates to a facility for documenting a delivery process for objects, in particular packages or letters, with at least one mobile detection device, as described above, and an object detection facility, which is suitable, in the time interval between receiving the objects for the purpose of transporting them and the final delivery of the objects at the target location, for detecting the objects individually and storing them in the form of a data set in a database.

The invention is described in more detail below based on exemplary embodiments illustrated by way of example in the drawings, in which:

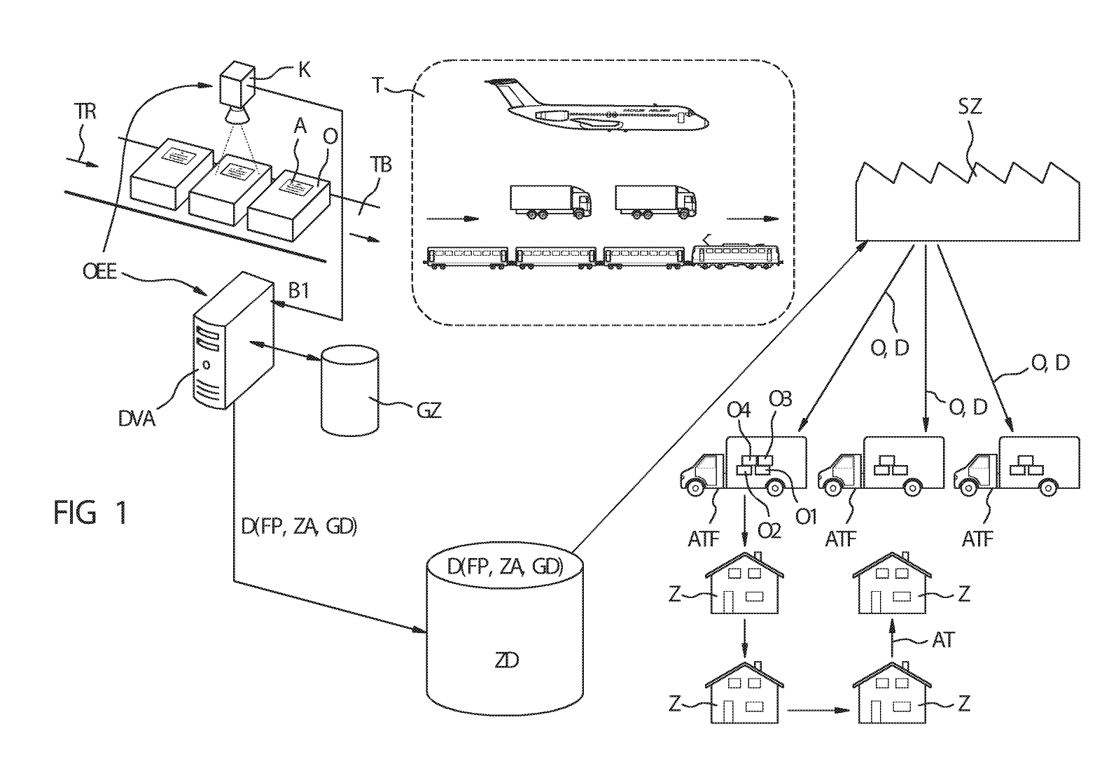

FIG. 1 shows the individual detection of objects to be delivered in the time interval between receiving the objects for the purpose of transporting them and the final delivery of the objects at the target location, the creation of individual data sets for each detected object and the storing of the data sets in a central database,

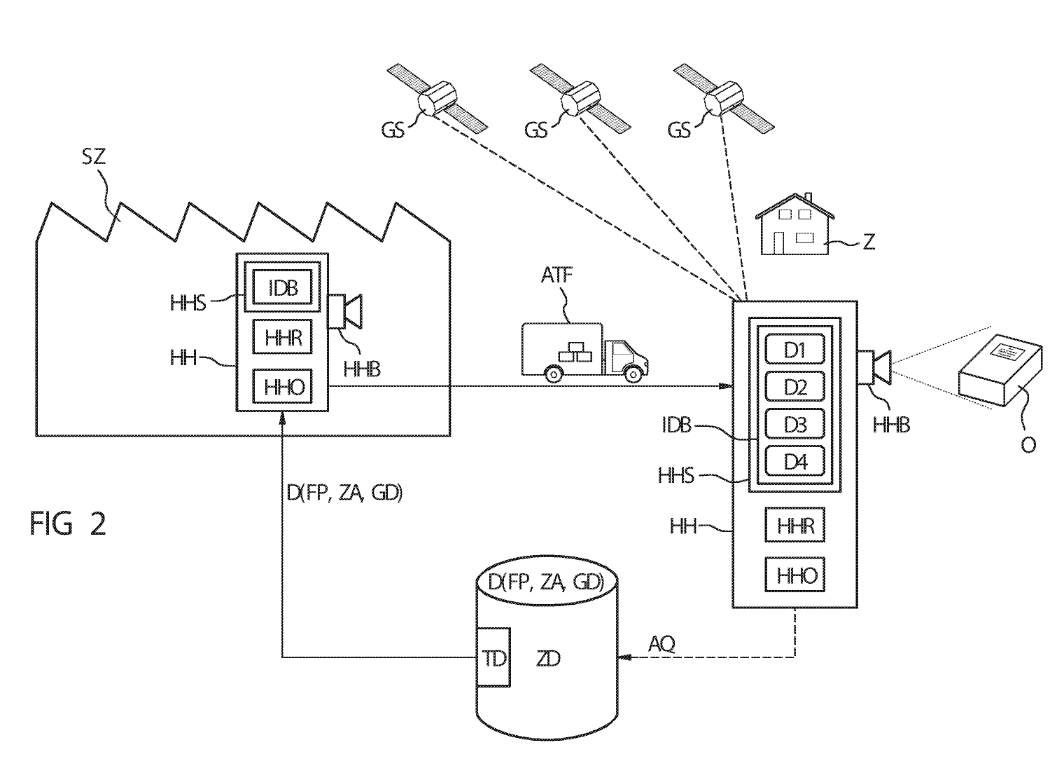

FIG. 2 shows the assignment of the objects during delivery to the respectively corresponding data sets which are stored in the database, the assignment taking place by means of a mobile detection device, and

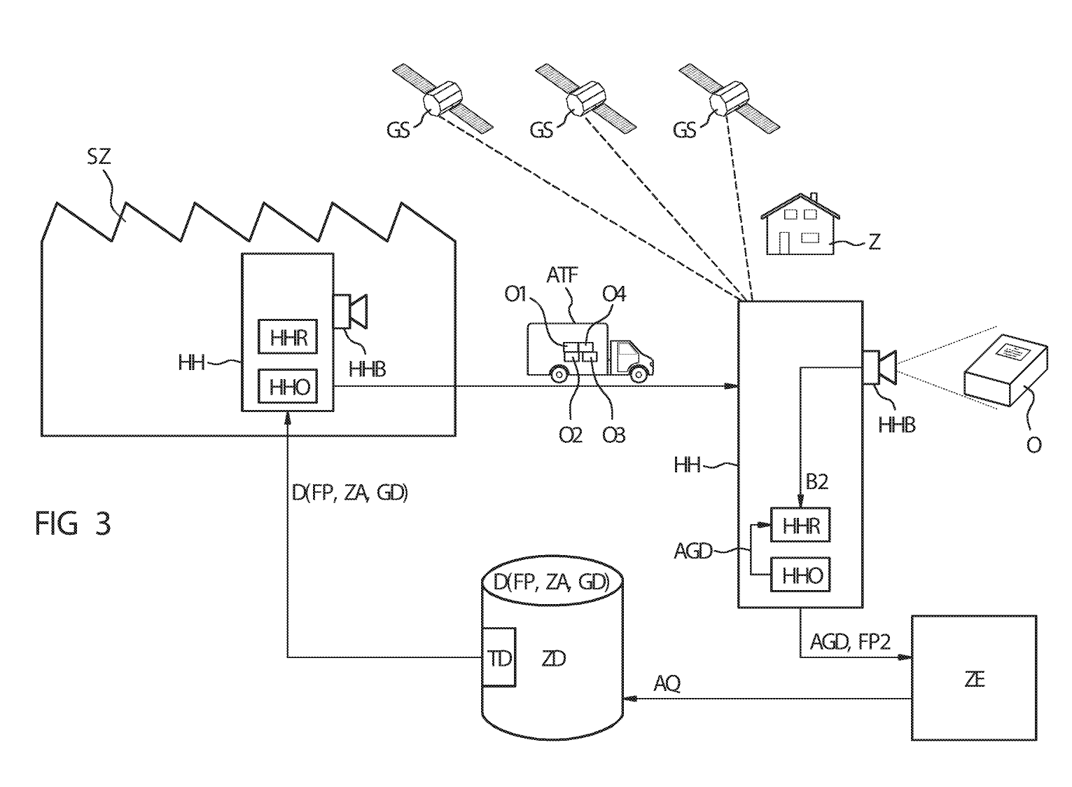

FIG. 3 shows the assignment of the objects during delivery to the respectively corresponding data sets which are stored in the database, the assignment taking place in an external central facility connected to the database.

The same reference characters are used for identical or comparable components in all the figures for the sake of clarity.

FIG. 1 shows by way of example how objects O with target addresses ZA, which are preferably shown in each instance in an address field A on the object, are moved by means of a transport means TB along a transport direction TR below a camera K, being scanned in the process. The camera K forms a component of an object detection facility OEE, to which along with the camera K a data processing system DVA also belongs. The images B1 recorded by the camera K are transferred to the data processing system DVA.

The data processing system DVA first determines the target addresses ZA of the objects O by reading the address fields A that can be identified in the recorded images B1 in an automated manner. The corresponding target geodata GD corresponding to the respective target addresses ZA is then determined for the target addresses ZA of the objects, by means of a geotarget database GZ connected to the data processing system DVA.

The corresponding target geodata GD is stored in the geotarget database GZ for a plurality of target addresses ZA, so that suitable reading of the geotarget database GZ allows the data processing system DVA to determine the appropriate target geodata GD for the respective target address ZA. A suitable geotarget database is provided for example by the Google service Google Maps.

For the target address ZA “Nonnendammallee 101 in Berlin” the data processing system DVA would generate for example the target geodata GD=“52.537455, 13.262857” in KML format (Keyhole Markup Language format).

The data processing system DVA also evaluates the image B1 supplied by the camera K for each object O in respect of image features or object features and extracts image features FP, which allow identification of the respective object O.

For each of the objects O the data processing system DVA therefore generates image features FP, target addresses ZA and target geodata GD, which are stored by the data processing system DVA in each instance in an object-specific data set D. The data sets D are transferred from the data processing system to a central database ZD and stored there.

After the objects O have been detected by means of the object detection facility OEE, the objects O are transported by means of one or more transport means T, which can be for example aircraft, trucks or trains, to a sorting center SZ which is located in proximity to a group of object targets Z. In the sorting center SZ the objects O transported thereto are distributed to delivery transport vehicles ATF, each of which takes a subset of the objects O to be delivered and transports them to a subset of object targets Z. The delivery drivers of the delivery transport vehicles ATF travel to the respective subsets of object targets as part of their delivery round AT so that the final delivery of the objects O can take place.

The mode of operation of the sorting center SZ is shown in more detail by way of example in FIG. 2. As the objects O are sorted for the delivery round AT according to FIG. 1 subdata TD is read from the central database ZD, said subdata TD containing inter alia the data sets D for all the objects O to be delivered on the delivery round AT. The subdata TD containing the data sets D is stored in an internal database IDB of a mobile detection device HH.

To store the subdata TD or to store the internal database IDB, the mobile detection device HH has a storage facility HHS, which is connected to a computation facility HHR of the mobile detection device HH. In addition to the storage facility HHS and the computation facility HHR the mobile detection device HH is equipped with an image recording facility HHB (for example in the form of a camera) and a locating facility HHO.

It is assumed by way of example in the following that the locating facility HHO is a GPS locating facility which can receive GPS signals from GPS satellites GS and determine the respective location of the mobile detection device HH by creating delivery geodata AGD. The locating facility can of course also determine the respective location of the mobile detection device HH and create the delivery geodata AGD in a different manner, for example by evaluating signals from mobile radio masts.

The delivery driver of the delivery transport vehicle ATF takes the mobile detection device HH along on the delivery round AT so the delivery driver can determine the delivery location or the delivery geodata AGD associated therewith by means of the locating facility HHO at each delivery location.

When an object is to be delivered, the delivery driver will record an image of the object to be delivered in each instance using the image recording facility HHB, preferably recording the side with the address field A. The image B2 recorded by the image recording facility HHB is sent to the computation facility HHR which can evaluate the image B2 and extract image features FP2 from the image B2.

In order to allow assignment of the delivered object O to the corresponding data set D, which is stored in the internal database IDB of the mobile detection device HH, the computation facility HHR proceeds for example as follows:

First the computation facility HHR compares the respective delivery geodata AGD with the target geodata GD of all the data sets stored for the objects to be delivered in the internal database IDB and checks whether the target geodata of one of the objects O1, O2, O3 and O4 corresponds to the delivery geodata AGD at the respective delivery location. The computation facility HHR will assume this for example if the delivery geodata AGS defines a delivery location that is located within a predetermined distance of the target location defined by the target geodata GD of one of the data sets D1 to D4.

It is then assumed for example that four objects O1, O2, O3 and O4 are to be delivered on delivery round AT according to

FIG. 1 and that therefore four data sets D1, D2, D3 and D4 are stored in the storage facility HHS, each relating to one of the objects O1, O2, O3 and O4 to be delivered according to FIG. 1.

If the computation facility HHR ascertains for example that only the target geodata of one data set, for example that of data set D3 relating to the object O3, corresponds to the delivery geodata AGD at the delivery location, it assumes that the object just delivered is the object O3 and will generate a delivery receipt AQ confirming delivery of the object O3. The delivery receipt AQ is preferably added to the data set D3 for the object O3.

If however by way of example the computation facility HHR ascertains that the delivery geodata AGD alone does not allow unambiguous assignment to a single data set D1, D2, D3 or D4, because for example two data sets D2 and D3 have corresponding target geodata GD, it will undertake an assignment of the object O just delivered to one of the data sets D2 or D3 preferably based on the image features FP2. For example it will compare the image features FP2 extracted from the image B2 with the image features FP of the two data sets D2 and D2 and select the data set in which the image features FP are most like the image features FP2. In this manner for example it will select the data set D3 relating to the object O3 and generate a delivery receipt AQ confirming delivery of the object O3. The delivery receipt AQ is preferably added to the data set D3 for the object O3.

The delivery receipts AQ or the data sets D to which the delivery receipts AQ have been added can be transferred from the mobile detection device HH immediately after delivery of the respective objects O to the central database ZD, for example by mobile radio. Alternatively it is possible for the delivery receipts AQ or the data sets D to which the delivery receipts AQ have been added to be stored first in the storage facility HHS of the mobile detection device HH and for the transfer of the delivery receipts AQ or the data sets D to which the delivery receipts AQ have been added to the central database ZD only to take place when the mobile detection device HH returns to the sorting center SZ after completion of the delivery round AT.

FIG. 3 shows by way of example that an assignment of the respectively delivered object to a data set D stored in the database ZD can also take place away from the mobile detection device HH, for example in a central facility ZE. With such an embodiment the mobile detection device HH can transfer the delivery geodata AGD together with the associated image features FP2 of the image B2 to the central facility ZE on every delivery; assignment to the respectively associated data set D of the central database ZD and generation of the delivery receipt AQ then take place in the central facility ZE.

Although the invention has been illustrated and described in detail using preferred exemplary embodiments, the invention is not limited by the disclosed examples and other variations can be derived therefrom by the person skilled in the art without departing from the scope of protection of the invention.

1-12. (canceled)

13. A method for documenting a delivery process for objects, which comprises the steps of:
detecting each of the objects individually and storing data on detected objects in a form of data sets, in a database during a time interval between receiving the objects for a purpose of transporting the objects and a final delivery of the objects at a target location;
during or after delivery of each object at the target location, designating the object as delivered in a data set, assigned to the object;
adding in a context of individual detection of the objects target geodata that defines the target location to the data set;
determining delivery geodata that defines a delivery location by means of a mobile detection device on delivery of the object at the target location;
wherein an assignment of a respectively delivered object to one of the datasets stored in the database also requires at least that the target geodata corresponds to the delivery geodata;
wherein in the context of the individual detection of the objects, producing an image for each of the objects and image features of the image produced are stored in the data set;
producing a further image on delivery of the object at the target location;
comparing image features of the further image with the image features of the data sets stored in the database; and
wherein an assignment of a delivered object to one of the data sets stored in the database also takes place at least based on a result of an image comparison; and
wherein the image comparison between the image features of the further image recorded on delivery at the target location and the image features of the data sets stored in the database takes place in a restricted manner, solely using the image features of the data sets, for which the target geodata corresponding to the delivery geodata is stored in the database.

14. The method according to claim 13, wherein an assignment of the delivered object to one of the data sets stored in the database takes place only if at least the image features of the further image produced on delivery of the delivered object at the target location are identical or at least sufficiently similar to the image features of one of the data sets stored in the database and the target geodata corresponds to the delivery geodata.

15. The method according to claim 13, wherein the delivery geodata and the target geodata are deemed to correspond, if the delivery geodata defines the delivery location which is located within a predetermined distance of the target location defined by the target geodata.

16. The method according to claim 13, wherein in an event of ambiguity in the assignment of the delivered object to the data sets stored in the database, all the data sets, under consideration based on the image comparison or at least the image features of the data sets, under consideration are displayed on the mobile detection device at the delivery location.

17. The method according to claim 16, wherein the assignment of the delivered object to one of the data sets, stored in the database takes place based on a selection signal input into the mobile detection device by a delivery operator delivering the object after the objects under consideration based on the ambiguity have been displayed.

18. The method according to claim 13, wherein in a context of the detection of the objects a recipient name in each instance is added to the data set, and in an event of any ambiguity in the assignment of the object to the data sets, stored in the database all the data sets, under consideration based on the image comparison, or at least the recipient name stored in the data sets, are displayed on the mobile detection device at the delivery location.

19. The method according to claim 18, wherein the assignment of the delivered object to one of the data sets, stored in the database takes place based on a selection signal input into the mobile detection device by a delivery operator delivering the object after the recipient name under consideration based on the ambiguity have been displayed.

20. The method according to claim 13, wherein before a start of a delivery process relating to the objects, the data sets relating to the objects and stored in the database are transferred to the mobile detection device to be used for their delivery and stored there.

21. The method according to claim 20, which further comprises performing the image comparison as a restricted image comparison, and the restricted image comparison taking place using a computation facility of the mobile detection device based on the data sets stored on the mobile detection device.

22. The method according to claim 13, which further comprises transferring the image features of the further images recorded by the mobile detection device and the delivery geodata to a central facility and the image comparison takes place based on the image features of the further images recorded by the mobile detection device in the central facility.

23. The method according to claim 13, which further comprises selecting the objects from the group consisting of packages and letters.

24. A mobile detection device for documenting a delivery process for objects, the mobile detection device comprising:
a locating facility for generating delivery geodata;
an image recording facility for producing an image of an object to be delivered;
a storage facility for receiving and storing data sets, relating to the objects stored in a database of a central facility and a delivery of an object is to be detected by means of the mobile detection device; and
a computation facility for performing a restricted image comparison based on the data sets, stored on the mobile detection device.

25. A facility for documenting a delivery process for objects, comprising:
at least one mobile detection device according to claim 24; and
an object detection facility, which is suitable, in a time interval between receiving the objects for transporting the objects and a final delivery of the objects at the target location, for detecting the objects individually and storing the objects in a form of a data set, in the database.
